(19) United States
(12) Patent Application Publication
(10) Pub. No.: US 2014/0019778 A1
(43) Pub. Date: Jan. 16, 2014

(54) HUB DEVICE

(71) Applicant: Ying-Hao Lin, New Taipei (TW)

(72) Inventor: Ying-Hao Lin, New Taipei (TW)

(73) Assignee: GOOD WAY TECHNOLOGY CO., LTD, New Taipei (TW)

(21) Appl. No.: 13/546,659

(22) Filed: Jul. 11, 2012

(51) Int. Cl. G06F 1/26

(52) U.S. Cl. 713/300

(57) ABSTRACT

A hub device for overcoming limits to charging and data transmission functions thereof includes a switching unit having a switch and a switching circuit; a first electrical connection port electrically connected to the switching circuit and for an electronic computing device to electrically connect thereto; a plurality of second electrical connection ports electrically connected to the switching circuit and for portable electronic devices to electrically connect thereto to get power supply therefrom; and a power supply connection unit electrically connected to the switching circuit. Through operation of the switch, the switching circuit can switch at least one of the second electrical connection ports from a charging downstream port to a dedicated charging port while all other second electrical connection ports are maintained as charging downstream ports for data transmission or charging function. Thus, the hub device is more convenient and practical for use.

### FIELD OF THE INVENTION

The present invention relates to a hub device, and more particularly to a hub device that allows part of second electrical connection ports thereof to be switched from charging downstream ports to dedicated charging ports while all other second electrical connection ports are maintained as charging downstream ports for data transmission or charging function.

### BACKGROUND OF THE INVENTION

A conventional hub device 4, such as that shown in FIG. 1, has an end connected to a personal computer 5 and another end connected to at least one portable electronic device 6, such that the portable electronic devices 6 connected to the hub device 4 can be charged and data transmission between the personal computer 5 and the portable electronic devices 6 can be performed via the hub device 4.

The conventional hub device 4 is inconvenient for use because it includes only charging downstream ports (CDP) and accordingly, the portable electronic devices 6 connected thereto could not be quickly charged to largely extend the charging time. Moreover, the conventional hub device 4 does not allow switching of part of its charging downstream ports to dedicated charging ports (DCP) while maintaining all other charging downstream ports for normal use.

It is therefore tried by the inventor to develop an improved hub device that allows part of electrical connection ports thereof to be switched from charging downstream ports to dedicated charging ports while all other electrical connection ports are maintained as charging downstream ports for data transmission or charging function.

### SUMMARY OF THE INVENTION

A primary object of the present invention is to provide an improved hub device that allows part of electrical connection ports thereof to be switched from charging downstream ports to dedicated charging ports while all other electrical connection ports are maintained as charging downstream ports for data transmission or charging function.

To achieve the above and other objects, the hub device according to the present invention includes a switching unit, a first electrical connection port, a plurality of second electrical connection ports, and a power supply connection unit. The switching unit includes a switch and a switching circuit, and the switch is electrically connected to the switching circuit. The first electrical connection port is electrically connected to the switching circuit and configured for an electronic computing device to electrically connect thereto. The second electrical connection ports are electrically connected to the switching circuit. Each of the second electrical connection ports is configured for a portable electronic device to electrically connect thereto, so as to supply power to the portable electronic device and enable data transmission between the portable electronic device and the electronic computing device. The power supply connection unit is also electrically connected to the switching circuit. Through operation of the switch, the switching circuit can switch at least one of the second electrical connection ports from a charging downstream port (CDP) to a dedicated charging port (DCP) while all other second electrical connection ports are maintained as charging downstream ports for data transmission or charging.

In the present invention, the portable electronic devices can be mobile phones, PDAs, A/V players, tablet computers, recording pens, keyboards, mice, flash drives or card readers.

In the present invention, the electronic computing device can be a desktop computer or a notebook computer.

With the above arrangements, the hub device according to the present invention allows part of the second electrical connection ports thereof to be switched from charging downstream ports to dedicated charging circuit while all other second electrical connection ports are maintained as charging downstream port for data transmission or charging function.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view showing the use of a conventional hub device;

FIG. 2 is a block diagram of a hub device according to a preferred embodiment of the present invention;

FIG. 3 is a circuit diagram of a switching unit for the hub device according to the preferred embodiment of the present invention;

FIG. 4 is a circuit diagram of a first electronic connection port for the hub device according to the preferred embodiment of the present invention;

FIGS. 5A to 5D are circuit diagrams of second electronic connection ports for the hub device according to the preferred embodiment of the present invention; and

FIG. 6 is a circuit diagram showing the power supply of the hub device according to the preferred embodiment of the present invention.

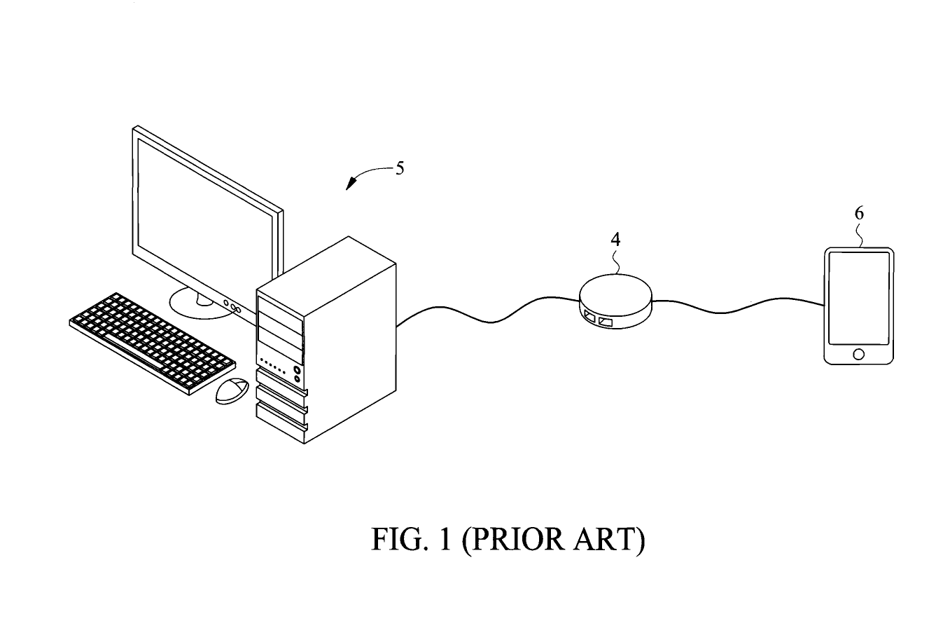

### DETAILED DESCRIPTION OF THE PREFERRED EMBODIMENTS

The present invention will now be described with a preferred embodiment thereof and with reference to the accompanying drawings.

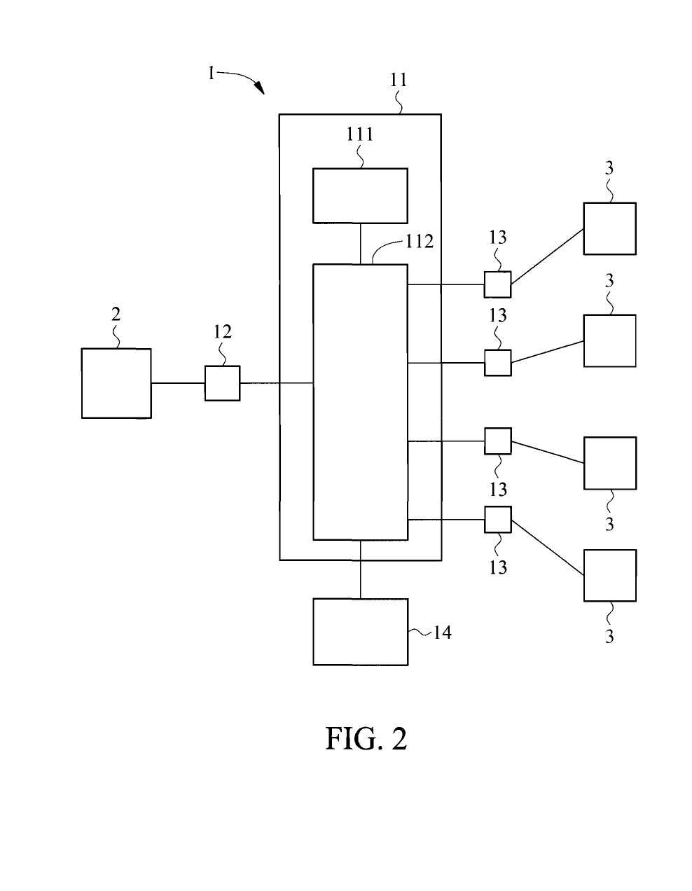

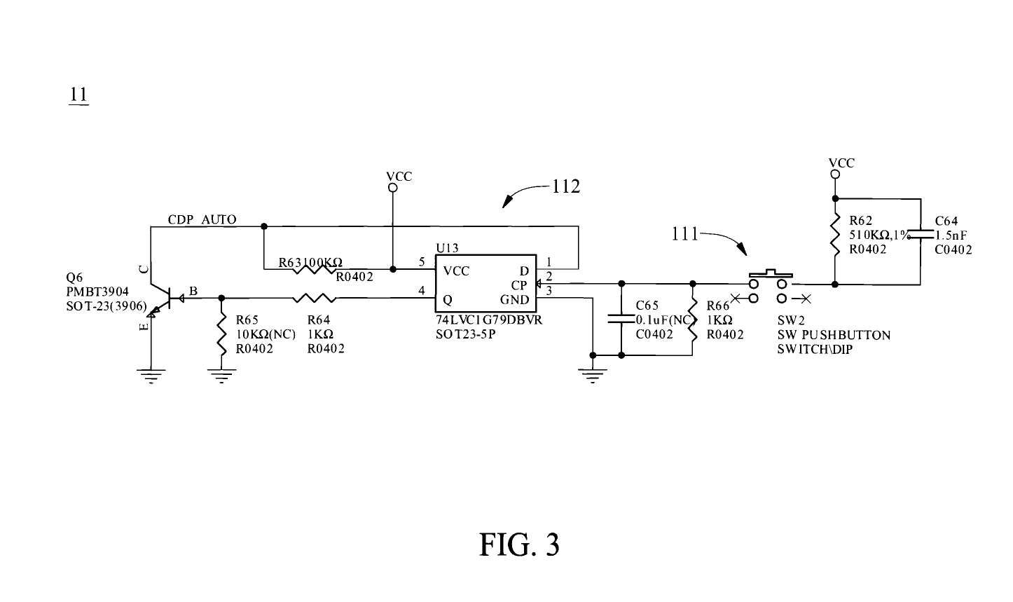

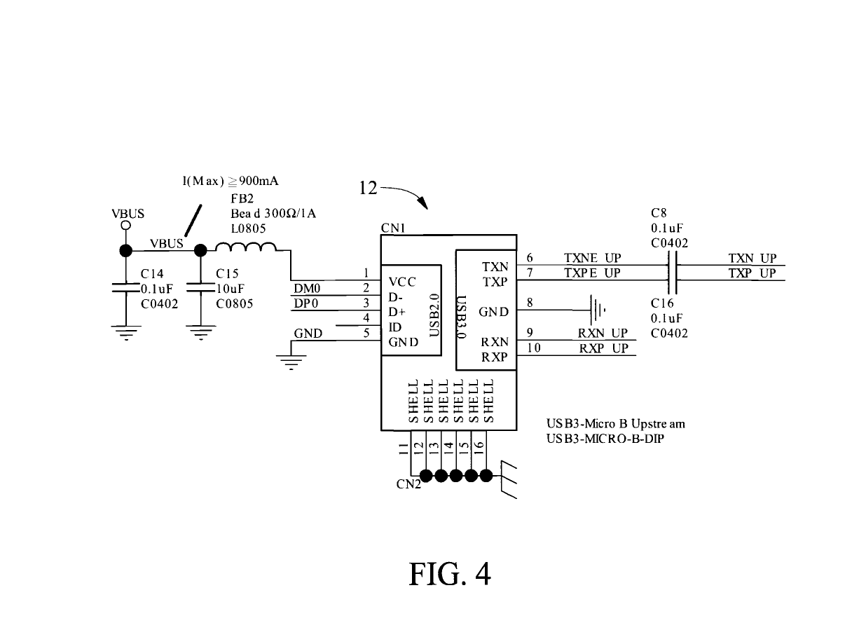

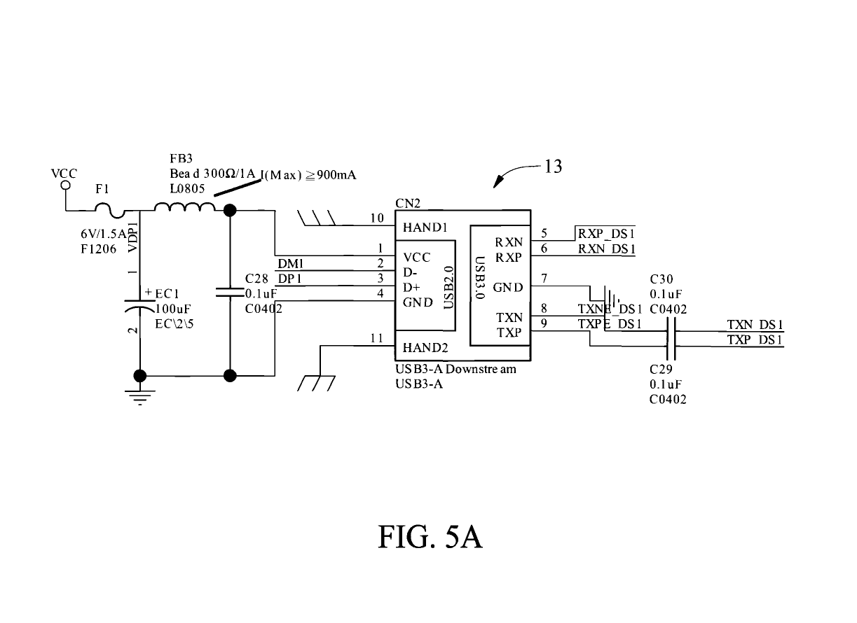

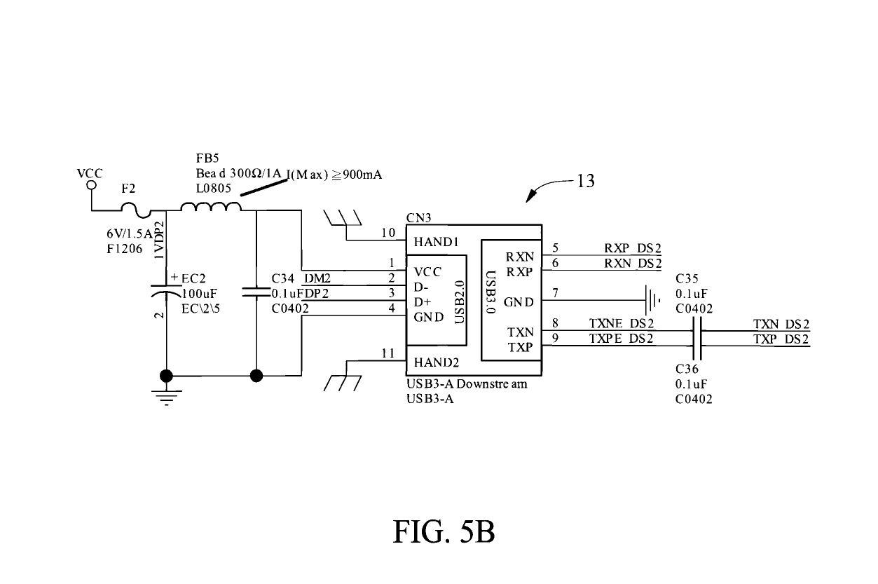

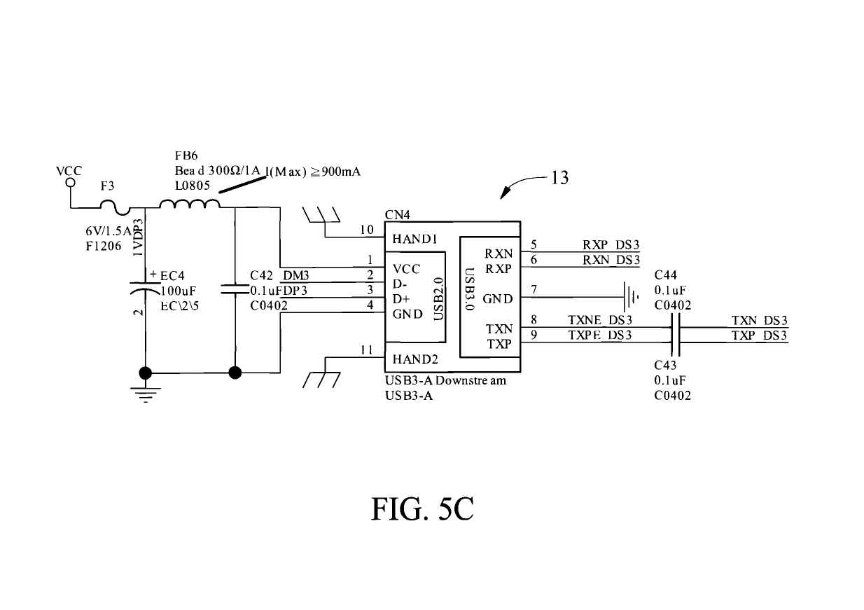

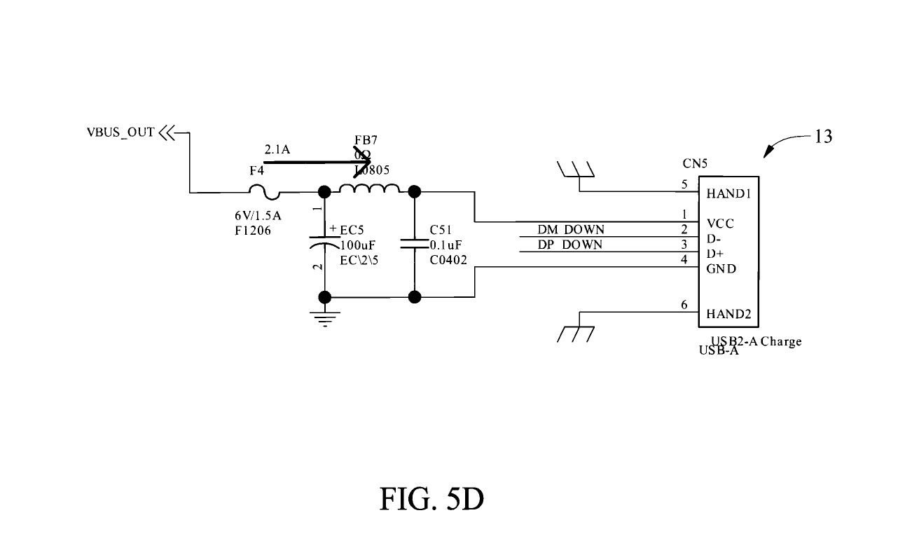

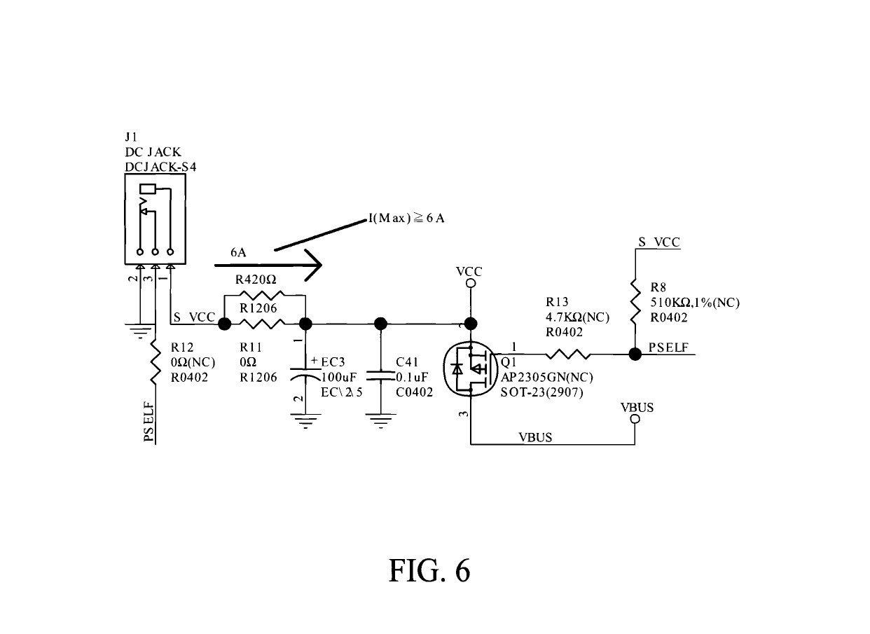

Please refer to FIG. 2 that is a block diagram of a hub device 1 according to a preferred embodiment of the present invention. As shown, the hub device 1 includes a switching unit 11, a first electrical connection port 12, a plurality of second electrical connection ports 13, and a power supply connection unit 14. FIG. 3 is a circuit diagram of the switching unit 11. Please refer to FIGS. 2 and 3 at the same time. The switching unit 11 includes a switch 111 and a switching circuit 112. The switch 111 is electrically connected to the switching circuit 112, and can be a push-button switch, a toggle switch, a side knob (horizontal) switch, or a rotary switch. FIG. 4 is a circuit diagram of the first electrical connection port 12. Please refer to FIGS. 2 and 4 at the same time. The first electrical connection port 12 is electrically connected to the switching circuit 112 and is configured for an electronic computing device 2 to connect thereto. In the present invention, the first electrical connection port 12 can be a universal serial bus (USB) 2.0 or 3.0. FIGS. 5A to 5D are circuit diagrams of the second electrical connection ports 13. Please refer to FIGS. 2 and 5A to 5D at the same time. The second electrical connection ports 13 are electrically connected to the switching circuit 112. Each of the second electrical connection ports 13 is configured for a portable electronic device 3 to electrically connect thereto to get power supply therefrom. The portable electronic device 3 connected to the second electrical connection port 13 can also transmit and receive data to and from the electronic computing device 2 connected to the first electrical connection port 12. In the present invention, the second electrical connection ports 12 each can be a universal serial bus (USB) 2.0 or 3.0. FIG. 6 is a circuit diagram showing the power supply of the hub device 1 according to the preferred embodiment of the present invention. Please refer to FIGS. 2 and 6 at the same time. The power supply connection unit 14 can be electrically connected to the switching circuit 112 via the leftmost connector of FIG. 6. In the present invention, the power supply connection unit 14 can be an electric cord for electrically connecting to an external power source, such as a household power supply. Through operation of the switch 111, the switching circuit 112 can switch at least one of the second electrical connection ports 13, such as the connector shown in FIG. 5D, from a charging downstream port (CDP) to a dedicated charging port (DCP) while all other second electrical connection ports 13 are maintained as charging downstream ports for data transmission or charging.

When the hub device 1 of the present invention is operated in a normal mode, the electronic computing device 2 can transmit and receive data to and from the portable electronic devices 3 via the first electrical connection port 12, the switching circuit 112 and the second electrical connection ports 13 while charging the portable electronic devices 3 at the same time. That is, the second electrical connection ports 13 are charging downstream ports (CDP) in compliance with USB BC1.1 and the charging power comes from the electronic computing device 2 or the external power source, such as the household power, electrically connected to the power supply connection unit 14 of the hub device 1. The charging current can be as high as 1.5 A or even 1.8 A. On the other hand, when the hub device 1 of the present invention is operated in a quick-charging mode, more than one of the second electrical connection ports 13, such as the connector shown in FIG. 5D, can be switched by the hub device 1 through operation of the switch 111 of the switching unit 11 to only supply power to the portable electronic devices 3 without transmitting data. The charging power comes from the external power source, such as the household power, electrically connected to the power supply connection unit 14 of the hub device 1, and the charging current can be as high as 5 A. That is, multiple second electrical connection ports 13 can be switched from charging downstream ports (CDP) to dedicated charging ports (DCP) in compliance with USN BC 1.2, while all other second electrical connection ports 13 are maintained as charging downstream ports for data transmission or charging.

In the present invention, the portable electronic devices 3 can be any electronic devices that require charging, such as mobile phones, personal digital assistants (PDAs), A/V players, tablet computers, recording pens and the like; or be any electronic devices that do not require charging but require power supply, such as keyboards, mice, flash drives, card readers and the like.

In the present invention, the electronic computing device 2 can be a desktop computer, a notebook computer or the like.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A hub device, comprising:
a switching unit including a switch and a switching circuit, and the switch being electrically connected to the switching circuit;
a first electrical connection port being electrically connected to the switching circuit and configured for an electronic computing device to electrically connect thereto;
a plurality of second electrical connection ports being electrically connected to the switching circuit; each of the second electrical connection ports being configured for a portable electronic device to connect thereto, so as to supply power to the portable electronic device and enable data transmission between the portable electronic device and the electronic computing device; and
a power supply connection unit being electrically connected to the switching circuit;
wherein, through operation of the switch, the switching circuit can switch at least one of the second electrical connection ports from a charging downstream port (CDP) to a dedicated charging port (DCP) while all other second electrical connection ports are maintained as charging downstream ports for data transmission or charging.

2. The hub device as claimed in claim 1, wherein the portable electronic devices are selected from the group consisting of mobile phones, PDAs, A/V players, tablet computers, recording pens, keyboards, mice, flash drives, and card readers.

3. The hub device as claimed in claim 1, wherein the electronic computing device is selected from the group consisting of a desktop computer and a notebook computer.

4. The hub device as claimed in claim 2, wherein the electronic computing device is selected from the group consisting of a desktop computer and a notebook computer.
